(19) United States
(12) Patent Application Publication
(10) Pub. No.: US 2019/0384119 A1
(43) Pub. Date: Dec. 19, 2019

(54) LIQUID CRYSTAL PANEL AND POLARIZER THEREOF

(71) Applicant: HUIZHOU CHINA STAR OPTOELECTRONICS TECHNOLOGY CO., LTD., Huizhou Guandong (CN)

(72) Inventor: Bo HAI, Huizhou Guangdong (CN)

(21) Appl. No.: 15/752,557

(22) PCT Filed: Jan. 26, 2018
(86) PCT No.: PCT/CN2018/074296

§ 371 Date: Nov. 16, 2018

(30) Foreign Application Priority Data
Jan. 16, 2018 (CN) 201810038149.7

(51) Int. Cl. G02F 1/1335

(52) U.S. Cl. CPC G02F 1/133617; G02F 2201/501; G02F 1/133528

(57) ABSTRACT

The present invention provides a liquid crystal display and a polarizer thereof. The polarizer including an adhesive layer, a compensation film layer, a polarizing layer, a fluorescent layer, the compensation film layer and the polarizing layer are disposed between the adhesive layer and the fluorescent layer, the polarizing layer is disposed between the compensation film layer and the fluorescent layer, the fluorescent layer including a quantum dots layer and a protective layer, wherein a material of the fluorescent layer is a water and oxygen resisting material, to make a water permeability of the fluorescent layer less than 10⁻¹ g/(m²˜24 h) and an oxygen permeability less than 10⁻¹ cm³/(m²·24 h·0.1 MPa). The material of the fluorescent layer is the water resistant and oxygen resistant material to ensure the excitation efficiency of the quantum dots layer, and enhance the stability of the polarizer.

### RELATED APPLICATIONS

The present application is a National Phase of International Application Number PCT/CN2018/074296, filed Jan. 26, 2018, and claims the priority of China Application No. 201810038149.7, filed Jan. 16, 2018.

### FIELD OF THE DISCLOSURE

The disclosure relates to a liquid crystal display technical field, and more particularly to a liquid crystal panel and a polarizer thereof.

### BACKGROUND

Quantum dots, QDs material are excited by blue light to generate fluorescent radiation and emit light, and there is no directional selectivity of the fluorescent radiation. Therefore, the fluorescence is radiated to the 360° undifferentiated after the excitement, and the viewing angle can be effectively improved, so that it has been widely used in the field of display technology in recent years. Conventional quantum dots material is a material with no resistant to moisture and oxygen. It is usually necessary to design a protective layer to protect the quantum dots material. The existing protective layer cannot achieve the standard of water permeability and oxygen permeability and can be easily reduced the excitation efficiency of the quantum dots material, and even make the quantum dots material b failure.

### SUMMARY

In order to solve the insufficiency of the conventional technology, the present invention provides a liquid crystal display and a polarizer thereof having low water permeability and oxygen permeability, and can improve the stability of the polarizer, improve the viewing angle of the liquid crystal display and improve the color gamut of the liquid crystal display.

The specific technical solution provided by the present invention is to provide a polarizer including an adhesive layer, a compensation film layer, a polarizing layer, a fluorescent layer, the compensation film layer and the polarizing layer are disposed between the adhesive layer and the fluorescent layer, the polarizing layer is disposed between the compensation film layer and the fluorescent layer, the fluorescent layer includes a quantum dots layer and a protective layer, wherein a material of the fluorescent layer is a water and oxygen resisting material, to make a water permeability of the fluorescent layer less than 10⁻¹ g/(m²·24 h) and an oxygen permeability less than 10⁻¹ cm³/(m²·24 h·0.1 MPa).

Alternatively, the quantum dots layer is formed by mixing quantum dots and a polymer matrix into a film.

Alternatively, a material of the quantum dots is a water resistant material, a material of the protective layer is an oxygen resistant material.

Alternatively, a material of the quantum dots is an oxygen resistant material, a material of the protective layer is a water resistant material.

Alternatively, a material of the quantum dots is a water resistant material, a material of the polymer matrix is a water resistant material or an oxygen resistant material or a water and oxygen resistant material, a material of the protective layer is an oxygen resistant material or a water resistant material or a water and oxygen resistant material.

Alternatively, a material of the quantum dots is an oxygen resistant material, a material of the polymer matrix is a water resistant material or an oxygen resistant material or a water and oxygen resistant material, a material of the protective layer is an oxygen resistant material or a water resistant material or a water and oxygen resistant material.

Alternatively, a material of the quantum dots is a water and oxygen resistant material, a material of the polymer matrix is a water resistant material or an oxygen resistant material or a water and oxygen resistant material, a material of the protective layer is an oxygen resistant material or a water resistant material or a water and oxygen resistant material.

Alternatively, the quantum dots layer includes green quantum dots and red quantum dots.

The present application further provides a liquid crystal display, the liquid crystal display including a backlight module and a display module, the display module including a lower polarizer, a lower substrate, a liquid crystal layer, an upper substrate and an upper polarizer disposed away from the backlight module sequentially, the lower polarizer is the polarizer as described above.

The polarizer provided by the invention includes an adhesive layer, a compensation film layer, a polarizing layer and a fluorescent layer. The material of the fluorescent layer is an oxygen resistant material, so that the water permeability of the fluorescent layer is less than 10⁻¹ g/(m²·24 h) and an oxygen permeability less than 10⁻¹ cm³/(m²·24 h·0.1 MPa). By selecting the material of the fluorescent layer as the water resistant material, the water permeability of the fluorescent layer is less than 10⁻¹ g/(m²·24 h) and an oxygen permeability less than 10⁻¹ cm³/(m²·24 h·0.1 MPa), so as to ensure the quantum dot layer excitation efficiency, improve the stability of the polarizer, improve the viewing angle of the liquid crystal display and improve the color gamut of the liquid crystal display.

### BRIEF DESCRIPTION OF THE DRAWINGS

FIG. 1 is a schematic structural view of the polarizer in a first embodiment;

FIG. 2 is a schematic structural view of the liquid crystal display in the first embodiment;

FIG. 3 is a schematic structural view of the polarizer in a second embodiment;

FIG. 4 is a schematic structural view of the polarizer in a third embodiment;

FIG, 5 is a schematic structural view of the polarizer in a fourth embodiment; and

FIG. 6 is a schematic structural view of the polarizer in a fifth embodiment.

### DETAILED DESCRIPTION OF PREFERRED EMBODIMENTS

Hereinafter, embodiments of the present invention will be described in detail with reference to the accompanying drawings. However, the invention may be embodied in many different forms and should not be construed as limited to the specific embodiments set forth herein. Rather, these embodiments are provided to explain the principles of the invention and its practical application to thereby enable those of ordinary skill in the art to understand various embodiments of the invention and various modifications as are suited to the particular use contemplated. In the drawings, the same reference numerals will always be used to refer to the same elements.

### First embodiment

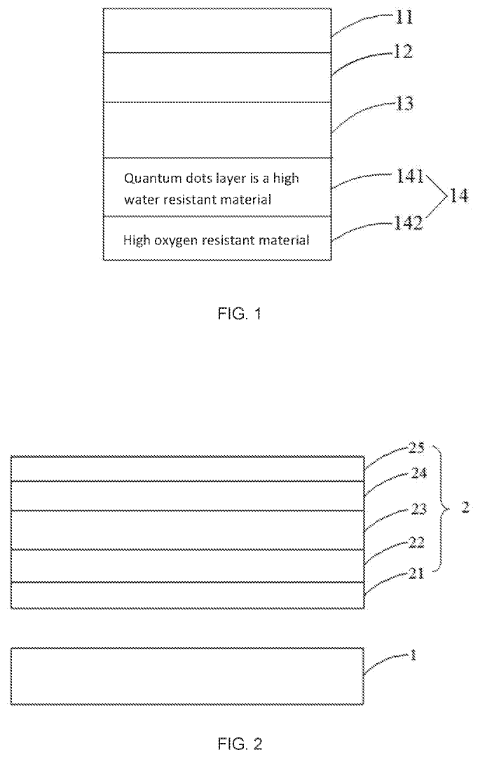

Referring to FIG. 1, a polarizer 10 provided in this embodiment includes an adhesive layer 11, a compensation film layer 12, a polarizing layer 13, a fluorescent layer 14, the compensation film layer 12 and the polarizing layer 13 are disposed between the adhesive layer 11 and the fluorescent layer 14, the polarizing layer 13 is disposed between the compensation film layer 12 and the fluorescent layer 14. The fluorescent layer 14 includes a quantum dots layer 141 and a protective layer 142. The fluorescent layer 14 is made of a water and oxygen resisting material, to make a water permeability less than 10⁻¹ g/(m²·24 h) and an oxygen permeability less than 10⁻¹ cm³/(m²·24 h·0.1 MPa).

Specifically, the quantum dots layer 141 is formed by mixing quantum dots and a polymer matrix into a film. The material of the quantum dots is a water resistant material, the material of the protective layer is an oxygen resistant material, so that the water permeability of the fluorescent layer 14 is less than 10⁻¹ g/(m²·24 h) and the oxygen permeability is less than 10⁻¹ cm³/(m²·24 h·0.1 MPa). Here, the material of the quantum dots is not a common water resistant material, but a high water resistant material, the high water resistant material here refers to a water resistant material capable of making the fluorescent layer 14 have a water permeability of less than 10⁻¹ g/(m²·24 h). The material of the protective layer is not a common oxygen resistant material but a high oxygen resistant material. The high oxygen resistant material refers to the oxygen resistant material capable of making the oxygen permeability of the fluorescent layer 14 less than 10⁻¹ cm³/(m²·24 h·0.1 MPa). Wherein, the water permeability of the fluorescent layer 14 less than 10⁻¹ g/(m²·24 h) means that the quantum dots in the water resistant stability and the excitation efficiency decay performance are equivalent to the conventional quantum dots membrane adapted as a water barrier layer. The oxygen permeability of the fluorescent layer 14 less than 10⁻¹ cm³/(m²·24 h·0.1 MPa) means that the quantum dots in the oxygen resistant stability and the excitation efficiency decay performance are equivalent to the conventional quantum dots membrane adapted as an oxygen barrier layer

In this embodiment, by combining the high water resistant quantum dots material with the highly oxygen resistant protective layer material to ensure the entire fluorescent layer 14 has low water permeability and oxygen permeability, so that no additional water resistant protective layer and oxygen resistant protection layer are needed, reducing the thickness of the entire polarizer, and enhance the stability of the polarizer

In this embodiment, the quantum dots layer 141 includes green quantum dots and red quantum dots The quantum dots layer 141 is formed by mixing green quantum dots, red quantum dots and a polymer matrix into the film.

The green quantum dots adopt an oil-soluble material and includes a light-emitting core and an inorganic protective shell, w herein the material of the light-emitting core is one selected from the group consisting of ZnCdSe₂, InP, Cd₂Sse, ZnCuInSₓSe_{y} and CuInSₓ: the material of the inorganic protean e shell is selected from CdS, ZnSe, ZnCdS₂, ZnS, ZnO, or a combination thereof.

The red quantum dots adopt an oil-soluble material and includes a light-emitting core and an inorganic protective shell, w herein the material of the light-emitting core is one selected from the group consisting of CdSe, Cd₂SeTe, InAs, ZnCulnSₓSe_{y} and CuInSₓ; the material of the inorganic protective shell is selected from CdS, ZnSe, ZnCdS₂, ZnS, ZnO, or a combination thereof.

The polymer matrix is selected from one of the group consisting of high molecular compounds such as acrylic resins, epoxy resins, cycloolefin polymers, organosilane resins and fiber esters. Preferably, the polymer matrix is a cycloolefin polymer, an organosilane resin and other high barrier materials

In this embodiment, the material of the polarizing layer 13 is PVA (polyvinyl alcohol), and the polarizing layer 13 plays a role of polarization. The compensation film layer 12 serves as a protective layer of the polarizing layer 13 and has the function of blocking water vapor and has the function of compensating for light leakage and color shift of large viewing angles. In addition, the compensation film layer 12 is also used for supporting the entire polarizer. The material of the adhesive layer 11 is PSA (pressure sensitive adhesive) and is used for adhering the compensation film layer 12 and a lower substrate, the lower substrate here refers to the TFT substrate in the liquid crystal display,

Referring to FIG. 2, the liquid crystal display further provided in this embodiment includes a backlight module 1 and a display module 2. The display module 2 is disposed above the backlight module 1, and the backlight module 1 provides a light source to the display module 2. The display module 2 includes a lower polarizer 21, a lower substrate 22, a liquid crystal layer 23, an upper substrate 24 and an upper polarizer 25 disposed away from the backlight module 1. Wherein the lower polarizer 21 is the polarizer 10, the upper substrate 24 is a CF substrate, and the lower substrate 22 is the TFT substrate.

The light emitted by the backlight module 1 enters the fluorescent layer 14, the quantum dots in the quantum dots layer 141 are excited to emit the fluorescence. The light emitted from the backlight module 1 and the fluorescence emitted from the quantum dots are mixed to form white light and emit from the quantum dots layer 141. Since the quantum dots material in all directions are within the quantum confinement size, the fluorescence radiation also does not have directional selectivity, so the fluorescence is radiated in 360° undiffused after the excitement and can effectively balance the brightness of the perspective of each viewing angle, to form a quantum dots architecture with high color gamut, wide viewing angle, and to improve the taste of the entire liquid crystal display.

### Second Embodiment

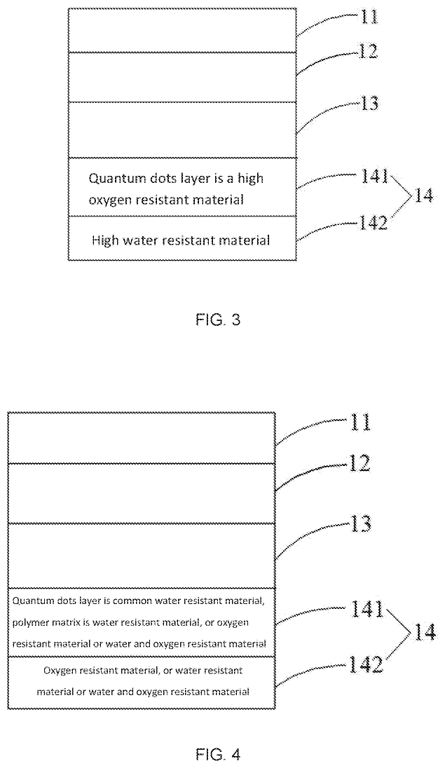

Referring to FIG. 3, the material of the quantum dots in this embodiment is a high oxygen resistant material, the material of the protective layer 142 is a high water resistant material, so that the water permeability of the fluorescent layer 14 is less than 10⁻¹ g/(m²·24 h), and the oxygen permeability is less than 10⁻¹ cm³/(m²·24 h·0.1 MPa).

### Third Embodiment

Referring to FIG. 4, the material of the quantum dots in this embodiment is the common water resistant material, the material of the polymer matrix is a water resistant material or an oxygen resistant material or an oxygen and water resistant material, the material of the protective layer 142 is the oxygen resistant material or the water resistant material, or the oxygen and water resistant material, so that the water permeability of the fluorescent layer 14 is less than 10⁻¹ g/(m²·24 h), and the oxygen permeability is less than 10⁻¹ cm³/(m²·24 h·0.1 MPa).

The material of the quantum dots is the common water resistant material, the material of the polymer matrix is the common water resistant material, the material of the protective layer 142 is a high oxygen resistant material, or the material of the quantum dots is the common water resistant material, the material of the polymer matrix is the common oxygen resistant material, the material of the protective layer 142 is the oxygen and water resistant material, or the material of the quantum dots is the common water resistant material, the material of the polymer matrix is a high oxygen resistant material, the material of the protective layer 142 is the common water resistant material, or the material of the dots is the common water resistant material, the material of the polymer matrix is an oxygen and water resistant material, the material of the protective layer 142 is the common oxygen resistant material, or the material of the quantum dots is the common water resistant material, the material of the polymer matrix is a high water resistant material, and the material of the protective layer 142 is a high oxygen resistant material.

Of course, this embodiment is not limited to the above mentioned several cases, as long as the quantum dots, the polymer matrix, the protective layer material is combined, so that the fluorescent layer 14 has the water permeability less than 10⁻¹ g/(m²·24 h), and the oxygen permeability less than 10⁻¹ cm³/(m²·24 h·0.1 MPa) can be or based on actual needs and product mix.

The common water resistant material, the common oxygen resistant material, and the common water and oxygen resistant material in this embodiment refer to compare with the conventional water impermeable materials, the oxygen impermeable materials and the water and oxygen impermeable materials have a certain degree of water resistance and oxygen resistance, however, after prolonged use, the water stability and excitation efficiency decay performance of the quantum dots is lower than conventional quantum dots membrane, to make the water permeability of the fluorescent layer 14 greater than or equal to 10⁻¹ g/(m²·24 h), and the oxygen permeability greater than or equal to 10⁻¹ cm³/(m²·24 h·0.1 MPa).

### Fourth Embodiment

Referring to FIG. 5, the material of the quantum dots in this embodiment is the common oxygen resistant material, the material of the polymer matrix is the water resistant material or the oxygen resistant material or the water and oxygen resistant material, the material of the protective layer 142 is the oxygen resistant material or the water resistant material, or the water and oxygen resistant material, to make the water permeability of the fluorescent layer 14 less than 10⁻¹ g/(m²·24 h), and the oxygen permeability less than 10⁻¹ cm³/(m²·24 h·0.1 MPa).

The material of the quantum dots is the common oxygen resistant material, the material of the polymer matrix is the common water resistant material, the material of the protective layer 142 is the water and oxygen resistant material, or the material of the quantum dots is the common oxygen resistant material, the material of the polymer matrix is the common oxygen resistant material, and the material of the protective layer 142 is the high water resistant material, or the material of the quantum dots is the common oxygen resistant material, the material of the polymer matrix is the high water resistant material, the material of the protective layer 142 is the common oxygen resistant material, or the material of the quantum dots is the common oxygen resistant material, the material of the polymer matrix is the water and oxygen resistant material, the material of the protective layer 142 is the common water resistant material, or the material of the quantum dots is the common oxygen resistant material, the material of the polymer matrix is the high water resistant material, and the material of the protective layer 142 is the high oxygen resistant material.

Of course, this embodiment is not limited to the above-mentioned several cases, as long as the materials of the quantum dots, the polymer matrix and the protective layer are combined to make the fluorescent layer 14 has a water permeability of less than 10⁻¹ g/(m²·24 h), and the oxygen permeability less than 10⁻¹ cm³/(m²·24 h·0.1 MPa) can be or based on actual needs and product mix.

### Fifth Embodiment

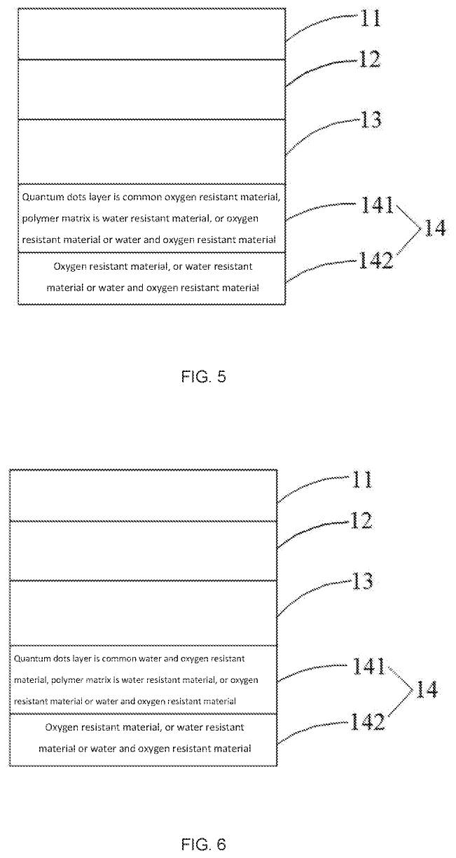

Referring to FIG. 6, the material of the quantum dots in this embodiment is the water and oxygen resistant material, the material of the polymer matrix is the water resistant material or the oxygen resistant material or the water and oxygen resistant material, and the material of the protective layer 142 is the oxygen resistant material or the water resistant material or water and oxygen resistant material.

The material of the quantum dots is the common water and oxygen resistant material, the material of the polymer matrix is the common water resistant material, the material of the protective layer 142 is the water and oxygen resistant material, or the material of the quantum dots is the common water and oxygen resistant material, the material of the polymer matrix is the common oxygen resistant material, the material of the protective layer 142 is the common water resistant material, or the material of the quantum dots is the common water and oxygen resistant material, the material of the polymer matrix is the high water resistant material, and the material of the protective layer 142 is the common oxygen resistant material, or the material of the quantum dots is the common water and oxygen resistant material, the material of the polymer matrix is the water and oxygen resistant material, and the material of the protective layer 142 is the high water resistant material or the high oxygen resistant material.

Of course, this embodiment is not limited to the above-mentioned several cases, as long as the materials of the quantum dots, the polymer matrix and the protective layer are combined to make the fluorescent layer 14 has a water permeability of less than 10⁻¹ g/(m²·24 h), and the oxygen permeability less than 10⁻¹ cm³/(m²·24 h·0.1 MPa) can be or based on actual needs and product mix.

The foregoing contents are detailed description of the disclosure in conjunction with specific preferred embodiments and concrete embodiments of the disclosure are not limited to these descriptions. For the person skilled in the art of the disclosure, without departing from the concept of the disclosure, simple deductions or substitutions can be made and should be included in the protection scope of the application.

What is claimed is:

1. A polarizer comprising: an adhesive layer, a compensation film layer, a polarizing layer, a fluorescent layer, the compensation film layer and the polarizing layer are disposed between the adhesive layer and the fluorescent layer, the polarizing layer is disposed between the compensation film layer and the fluorescent layer, the fluorescent layer comprising a quantum dots layer and a protective layer, wherein a material of the fluorescent layer is a water and oxygen resisting material, to make a water permeability of the fluorescent layer less than 10⁻¹ g/(m²·24 h) and an oxygen permeability less than 10⁻¹ cm³/(m²·24 h·0.1 MPa).

2. The polarizer according to claim 1, wherein the quantum dots layer is formed by mixing quantum dots and a polymer matrix into a film.

3. The polarizer according to claim 2, wherein a material of the quantum dots is a water resistant material, a material of the protective layer is an oxygen resistant material.

4. The polarizer according to claim 2, wherein a material of the quantum dots is an oxygen resistant material, a material of the protective layer is a water resistant material.

5. The polarizer according to claim 2, wherein a material of the quantum dots is a water resistant material, a material of the polymer matrix is a water resistant material or an oxygen resistant material or a water and oxygen resistant material, a material of the protective layer is an oxygen resistant material or a water resistant material or a water and oxygen resistant material.

6. The polarizer according to claim 2, wherein a material of the quantum dots is an oxygen resistant material, a material of the polymer matrix is a water resistant material or an oxygen resistant material or a water and oxygen resistant material, a material of the protective layer is an oxygen resistant material or a water resistant material or a water and oxygen resistant material.

7. The polarizer according to claim 2, wherein a material of the quantum dots is a water and oxygen resistant material, a material of the polymer matrix is a water resistant material or an oxygen resistant material or a water and oxygen resistant material, a material of the protective layer is an oxygen resistant material or a water resistant material or a water and oxygen resistant material.

8. The polarizer according to claim 2, wherein the quantum dots layer comprises green quantum dots and red quantum dots.

9. A liquid crystal display comprising a backlight module and a display module, the display module comprising a lower polarizer, a lower substrate, a liquid crystal layer, an upper substrate and an upper polarizer disposed away from the backlight module sequentially, the lower polarizer comprising: an adhesive layer, a compensation film layer, a polarizing layer, a fluorescent layer, the compensation film layer and the polarizing layer are disposed between the adhesive layer and the fluorescent layer, the polarizing layer is disposed between the compensation film layer and the fluorescent layer, the fluorescent layer comprising a quantum dots layer and a protective layer, wherein a material of the fluorescent layer is a water and oxygen resisting material, to make a water permeability of the fluorescent layer less than 10⁻¹ g/(m²·24 h) and an oxygen permeability less than 10⁻¹ cm³/(m²·24 h·0.1 MPa).

10. The polarizer according to claim 9, wherein the quantum dots layer is formed by mixing quantum dots and a polymer matrix into a film.

11. The polarizer according to claim 10, wherein a material of the quantum dots is a water resistant material, a material of the protective layer is an oxygen resistant material.

12. The polarizer according to claim 10, wherein a material of the quantum dots is an oxygen resistant material, a material of the protective layer is a water resistant material.

13. The polarizer according to claim 10, wherein a material of the quantum dots is a water resistant material, a material of the polymer matrix is a water resistant material or an oxygen resistant material or a water and oxygen resistant material, a material of the protective layer is an oxygen resistant material or a water resistant material or a water and oxygen resistant material.

14. The polarizer according to claim 10, wherein a material of the quantum dots is an oxygen resistant material, a material of the polymer matrix is a water resistant material or an oxygen resistant material or a water and oxygen resistant material, a material of the protective layer is an oxygen resistant material or a water resistant material or a water and oxygen resistant material.

15. The polarizer according to claim 10, wherein a material of the quantum dots is a water and oxygen resistant material, a material of the polymer matrix is a water resistant material or an oxygen resistant material or a water and oxygen resistant material, a material of the protective layer is an oxygen resistant material or a water resistant material or a water and oxygen resistant material.

16. The polarizer according to claim 10, wherein the quantum dots layer comprises green quantum dots and red quantum dots.
